(19) United States
(12) Patent Application Publication
(10) Pub. No.: US 2026/0259956 A1
(43) Pub. Date: Sep. 3, 2026

(54) INFORMATION DECOMPOSITION METHOD AND ELECTRONIC DEVICE

(71) Applicant: Lenovo (Beijing) Limited, Beijing (CN)

(72) Inventors: Xiaoyu JIN, Beijing (CN); Huishi QIU, Beijing (CN)

(21) Appl. No.: 19/535,752

(22) Filed: Feb. 10, 2026

(30) Foreign Application Priority Data
Feb. 28, 2025 (CN) 202510238181.X

(51) Int. Cl. G06F 17/40

(52) U.S. Cl. CPC G06F 17/40

(57) ABSTRACT

An information decomposition method includes obtaining an abstract meaning representation graph of to-be-processed information, splitting the abstract meaning representation graph according to attribute information of the to-be-processed information to obtain a plurality of abstract meaning representation subgraphs, and determining sub-information corresponding to each abstract meaning representation subgraph of the plurality of abstract meaning representation subgraphs. The abstract meaning representation graph includes a plurality of nodes and edges for connecting two of the plurality of nodes. A node represents a concept included in the to-be-processed information. An edge represents a semantic relation between two concepts. The abstract meaning representation subgraphs represent that the to-be-processed information includes at least one intention. A plurality of pieces of sub-information are results of decomposing the to-be-processed information.

### CROSS-REFERENCES TO RELATED APPLICATION

This application claims priority to Chinese Patent Application No. 202510238181.X, filed on Feb. 28, 2025, the entire content of which is incorporated herein by reference.

### FIELD OF TECHNOLOGY

The present disclosure relates to the information processing technology field and, more particularly, to an information decomposition method and an electronic device.

### BACKGROUND

Information decomposition is the most important basic task for natural language processing. Currently, during the process of performing information decomposition of a complex sentence, information is easily lost, which leads to inaccurate information analysis results.

### SUMMARY

One aspect of this disclosure provides an information decomposition method. The method includes obtaining an abstract meaning representation graph of to-be-processed information, splitting the abstract meaning representation graph according to attribute information of the to-be-processed information to obtain a plurality of abstract meaning representation subgraphs, and determining sub-information corresponding to each abstract meaning representation subgraph of the plurality of abstract meaning representation subgraphs. The abstract meaning representation graph includes a plurality of nodes and edges for connecting two of the plurality of nodes. A node represents a concept included in the to-be-processed information. An edge represents a semantic relation between two concepts. The abstract meaning representation subgraphs represent that the to-be-processed information includes at least one intention. A plurality of pieces of sub-information are results of decomposing the to-be-processed information.

Another aspect of this disclosure provides an electronic device, including one or more processors and one or more memories. The one or more memories store one or more computer programs that, when executed by the one or more processors, cause the one or more processors to obtain an abstract meaning representation graph of to-be-processed information, split the abstract meaning representation graph according to attribute information of the to-be-processed information to obtain a plurality of abstract meaning representation subgraphs, determine sub-information corresponding to each abstract meaning representation subgraph of the plurality of abstract meaning representation subgraphs. The abstract meaning representation graph includes a plurality of nodes and edges for connecting two of the plurality of nodes. A node represents a concept included in the to-be-processed information. An edge represents a semantic relation between two concepts. The abstract meaning representation subgraphs represent that the to-be-processed information includes at least one intention. A plurality of pieces of sub-information are results of decomposing the to-be-processed information.

Another aspect of this disclosure provides a computer-readable storage medium storing one or more computer programs that, when executed by one or more processors, cause the one or more processors to obtain an abstract meaning representation graph of to-be-processed information, split the abstract meaning representation graph according to attribute information of the to-be-processed information to obtain a plurality of abstract meaning representation subgraphs, determine sub-information corresponding to each abstract meaning representation subgraph of the plurality of abstract meaning representation subgraphs. The abstract meaning representation graph includes a plurality of nodes and edges for connecting two of the plurality of nodes. A node represents a concept included in the to-be-processed information. An edge represents a semantic relation between two concepts. The abstract meaning representation subgraphs represent that the to-be-processed information includes at least one intention. A plurality of pieces of sub-information are results of decomposing the to-be-processed information.

### BRIEF DESCRIPTION OF THE DRAWINGS

Through the description of embodiments of the present disclosure with reference to the accompanying drawings, the above and other purposes, features, and advantages of the present disclosure are clearer.

FIG. 1 is a schematic flowchart of information decomposition according to some embodiments of the present disclosure.

FIG. 2A is a schematic diagram of an abstract meaning representation graph before compression according to some embodiments of the present disclosure.

FIG. 2B is a schematic diagram of an abstract meaning representation graph after compression according to some embodiments of the present disclosure, to-be-processed information including at least two parallel intentions.

FIG. 3 is a schematic diagram of an abstract meaning representation subgraph according to some embodiments of the present disclosure, to-be-processed information including at least two parallel intentions.

FIG. 4A is a schematic diagram of another abstract meaning representation graph according to some embodiments of the present disclosure, to-be-processed information including at least two serial intentions.

FIG. 4B is a schematic diagram of another abstract meaning representation subgraph according to some embodiments of the present disclosure, to-be-processed information including at least two serial intentions.

FIG. 5 is a schematic diagram showing a principle of an information decomposition method according to some embodiments of the present disclosure.

FIG. 6 is a schematic structural diagram of an information decomposition apparatus according to some embodiments of the present disclosure.

FIG. 7 is a schematic block diagram of an electronic device suitable for implementing an information decomposition method according to some embodiments of the present disclosure.

### DETAILED DESCRIPTION

Embodiments of the present disclosure are described with reference to the accompanying drawings. However, it should be understood that these descriptions are merely exemplary and are not intended to limit the scope of the present disclosure. In the following detailed description, to facilitate explanation, many specific details are set forth to provide a thorough understanding of embodiments of the present disclosure. However, it is apparent that one or more embodiments can also be implemented without these specific details. In addition, in the following description, well-known structures and technologies are omitted so as not to unnecessarily obscure the concept of the present disclosure.

The terminology used herein is merely for describing particular embodiments, and is not intended to limit the present disclosure. The terms “comprising” and “including” can indicate the presence of features, steps, operations, and/or members, but do not preclude the presence or addition of one or more other features, steps, operations, or members.

All terms used herein (including technical and scientific terms) have the meanings commonly understood by those skilled in the art, unless otherwise defined. It should be noted that the terms used herein should be interpreted as having meanings consistent with the context of this specification and should not be interpreted in an idealized or overly rigid manner.

In cases where expressions such as “at least one of A, B, and C” are used, such expressions should generally be interpreted according to the meanings commonly understood by those skilled in the art (for example, “a system having at least one of A, B, or C” should include, but is not limited to, a system having A alone, B alone, C alone, A and B, A and C, B and C, and/or A, B, and C).

Embodiments of the present disclosure provide an information decomposition method and an electronic device. Before introducing the technical solutions of embodiments of the present disclosure, the related technologies of the present disclosure are first described.

Information decomposition is an important fundamental task in the syntactic analysis of natural language processing. At present, in the process of decomposing a complex sentence, a part of the information can be easily lost, resulting in inaccuracies in the analysis results of the information.

The retrieval-augmented generation method is an important method for applying large natural language models. In a retrieval-augmented system, a retriever generally performs well on simple problems, but faces the challenge of being unable to retrieve sufficient information about the semantics expressed by the question for complex problems involving multiple documents and multi-hop reasoning. For example, when the retrieval-augmented method faces a complex problem, such as a comparison or bridging question, a mismatch between search terms and the content granularity of the retrieval database, and a lack of key search information may become major obstacles affecting the performance of the retrieval-augmented system. According to a good performance feature of the retriever on simple problems within the retrieval-augmented system, the complex problem can be decomposed into smaller and more controllable sub-problems. This strategy of decomposing the complex problem can be effective for solving complex problems.

In an example, during decomposing the complex problem, and in an application system where a large language model is deployed on the device end, the complex problem can be decomposed by using a large language model in combination with a prompt-engineering method, such as chain-of-thought, few-shot learning, etc., without introducing an additional model. However, since the problem belongs to a complex task requiring reasoning and induction, a model with at least 3 billion parameters can have corresponding capabilities when using the large language model. Moreover, different models can have different effects, and the accuracy of the model result can be difficult to guarantee. To ensure the model to be able to effectively solve the problem, the model may need to adapt on purpose and optimize the prompt. Alternatively, the corresponding capability of the model can be fine-adjusted. Thus, additional requirements for supervised fine-tuning (SFT) data construction can be generated.

In another example, during decomposing the complex problem, the decomposition can be performed by additionally introducing a sequence-labeling model. This method can include adding a special label for spacing to decompose the original sentence or the semantic graph of the original sentence in the sequencing-labeling task to obtain decomposed sub-query sentences. However, to use the sequence-labeling model, a large amount of data can be needed for labeling and training. After fine-tuning, although the decomposition performance reaches the same level as the 3 billion-parameter large model, the capability can only be applied to the one task of the problem decomposition, and the utilization rate is not high. As a result, the utilization of the storage resources introduced additionally at the end can be limited. The sequence-labeling model can occupy a certain space, which can easily cause shortages of storage resources.

Before further describing embodiments of the present disclosure, the terms and vocabulary involved in embodiments of the present disclosure are explained, and the terms involved in the embodiments of the present disclosure apply to the following interpretations.

Abstract Meaning Representation (AMR) is a graphical representation method used to express the syntactic and semantic structure of natural-language sentences, which abstracts the core semantic content of a sentence into a set of concept nodes and semantic relation edges. Then, the deep semantics of the sentence can be captured in the form of a graph, without relying on a specific syntactic structure. Therefore, the AMR can represent a graph structure and can also be referred to as an abstract meaning representation graph, in which the node represents concepts (for example, actions, entities, attributes, etc.), i.e., the words appearing in the sentence corresponding to the abstract meaning representation graph, and the edge can represent the relationships between the concepts.

An AMR graph can contain a root node and a leaf node. The root node can be the starting point of the AMR graph and usually represents the main verb or concept of an entire sentence or event. The root node has no parent node. Each node has a parent node except the root node. A parent node is an upper-level node connected to a child node and represents a higher-level semantic concept. The leaf node is the end node of the AMR graph and has no child nodes. A child node is a node directly connected to a parent node, represents semantic information related to the parent node, and often describes participants and attributes of an event. The leaf node usually represents a specific entity, such as a personal name, place, and time, or other nouns and verbs.

An entity usually refers to a specific object or thing, typically the content indicated by a noun or pronoun. In an AMR graph, an entity usually refers to a thing that has a specific existence, such as people, places, time, objects, and so on, which is a specific existence that we can perceive or understand in the world. Ontology can be an abstract concept and can be a category or type used to represent a class or type of an object or concept. In an AMR graph, the ontology usually refers to the category, attribute, or feature of an entity, which describes the category to which an entity belongs or an abstract attribute of the entity, but does not directly represent a specific thing.

Embodiments of the present disclosure provides an information decomposition method, including obtaining an abstract meaning representation graph of to-be-processed information, the abstract meaning representation graph including a plurality of nodes and edges used to connect two nodes, the nodes representing concepts included in the to-be-processed information, and the edges representing semantic relationships between the two concepts, splitting the abstract meaning representation graph according to attribute information of the to-be-processed information to obtain a plurality of abstract meaning representation subgraphs, the abstract meaning representation subgraphs representing at least one intention included in the to-be-processed information, and determining sub-information corresponding to each abstract meaning representation subgraph, a plurality of pieces of sub-information being a result after decomposing the to-be-processed information.

The information decomposition method of embodiments of the present disclosure is described in detail with reference to FIGS. 1 to 5.

FIG. 1 is a schematic flowchart of information decomposition according to some embodiments of the present disclosure.

As shown in FIG. 1, the information decomposition method of this embodiment includes operations S210 to S230.

At S210, an abstract meaning representation graph of to-be-processed information is obtained, the abstract meaning representation graph including a plurality of nodes and an edge configured to connect two nodes, the node representing a concept included in the to-be-processed information, and the edge representing a semantic relationship between two concepts.

In some embodiments, the to-be-processed information can be a natural-language sentence containing complex information. The to-be-processed information can be a sentence, a paragraph, or text, which is not limited by embodiments of the present disclosure. The to-be-processed information can be a question sentence entered by the user. For example, the user can initiate a problem sentence, “what is the nationality of the inventor of the gravity?” The to-be-processed information can be the speech content of a presenter. The to-be-processed information can be a certain paragraph in the specification.

The abstract meaning representation graph (i.e., AMR graph) can represent language information of the to-be-processed information or a diagram of the semantic structure. The abstract meaning representation graph can represent the semantic relationships between the nodes and the edges to abstractly describe the semantic relationships between the concepts. In the abstract meaning representation graph, each node can represent a semantic concept. The concept is usually a part of the sentence having a semantic meaning, such as a person, a place, time, an action, an event, or a representation. Here, the node can be a real node corresponding to a word in the sentence. In some other embodiments, the node can be a node corresponding to information that is required. For example, when the sentence is a question, an arm-unknown node can be arranged. The left side can represent the semantic relationship between two neighboring concepts. Each edge and direction can represent a certain relationship between two concepts, such as actions, attribution, time, and so on.

At S220, according to the attribute information of the to-be-processed information, the abstract meaning representation graph is split to obtain a plurality of abstract meaning representation subgraphs, the abstract meaning representation subgraphs representing at least one intention included in the to-be-processed information.

Exemplarily, the attribute information can be logical information of the sentences in the to-be-processed information. For example, the attribute information can be the type of the sentence. The type of the sentence in the to-be-processed information can be a parallel-type question, such as a comparison type, or a bridging-type question, such as a causal-type or conditional-type question. A comparison-type question can include “What are the differences between urban life and rural life?” The attribute information can be the style of the sentence. For example, the type of the sentence in the to-be-processed information can be metaphor, personification, parallelism, exaggeration, etc.

An abstract meaning representation subgraph can be a partial graph split from the abstract meaning representation graph and can include a specific intention contained in the to-be-processed information.

Here, an intention can be a specific purpose or need expressed in the to-be-processed information. Since different words have different meanings in different contexts, when a plurality of words are connected to form a certain context, the meaning that the words intend to express can be inferred to determine the intention corresponding to the subgraph formed by the words. In each abstract meaning representation subgraph, through the relationship between the nodes and edges, a specific intention included in the abstract meaning representation subgraph can be identified. For example, in a text about order processing, one subgraph can represent the intention of “placing an order,” and another subgraph can represent the intention of “querying order status.”

At S230, sub-information corresponding to each abstract meaning representation subgraph is determined, and a plurality of pieces of sub-information are the result of decomposing the to-be-processed information.

Exemplarily, the sub-information can be a textual expression corresponding to the intention of the abstract meaning representation subgraph. One piece of sub-information can correspond to one piece of expression information. For example, the to-be-processed information (a query sentence): What is the nationality of the inventor of universal gravitation? can be decomposed into sub-information 1: Who is the inventor of universal gravitation, and sub-information 2: What is the nationality of the inventor. Sub-information 1 and sub-information 2 can be used to assist a natural language model in obtaining the query result for the question.

After being processed through a certain decomposition method, the to-be-processed information can be decomposed into smaller and more meaningful parts. These parts are usually organized and expressed in the form of abstract meaning representation subgraphs. In practical implementation, the complex information can be systematically decomposed into different pieces of sub-information. Each piece of sub-information can correspond to an abstract meaning representation subgraph.

The sub-information can be used in an information-retrieval scenario, for example, to answer a query sentence. The sub-information can also be used in an information-summarization scenario, for example, to extract a summary of an article.

It can be understood that, on one hand, through the form of an abstract meaning representation graph, the deep semantics in the to-be-processed information can be captured without relying on specific grammatical structures. Compared with traditional syntactic analysis and semantic parsing, the abstract meaning representation graph can focus more on the internal logic of the sentence rather than grammar, and can be more suitable for a question-decomposition task. On the other hand, the abstract meaning representation graph can be finely split for the to-be-processed information of different attributes to obtain the sub-graphs corresponding to the logic structure of the to-be-processed information and obtain the expression of the complete semantic information of the to-be-processed information. Simultaneously, in this method, a large model with a small parameter quantity can become a large model with a great parameter quantity, so as to have the complex problem decomposition capability and lower the application and hardware resource bar. The method can also be applied to assist other functional modules, such as document decomposition and document summarization of the application on the side of the large model. The utilization of the storage space can be higher.

An abstract meaning representation graph can reflect as many semantic details of a sentence as possible, for example, a simple entity may be represented using a plurality of nodes. However, the question-decomposition task may focus more on the logical relationship reflected by the overall graph structure. For example, in a comparison-type question, the most important task is to find the similar paths where the two comparison entities lie. Overly detailed graph-structure information can interfere with locating similar paths. Therefore, before splitting the abstract meaning representation graph, the abstract meaning representation graph can be compressed first to reduce information interference.

In some embodiments, the information decomposition method can further include, when the concept of the first target node represents the ontology, the sub-node related to the concept of the first target node can be compressed to replace the sub-node related to the concept of the first target node and the first target node. The ontology can represent a system of entities with the same attributes.

In some embodiments, the ontology can be an abstract expression of entities having the same attributes. The ontology can have a set of predefined entity types. For example, a ontology can be cities, countries, works of art, addresses, dates, people, etc. The type of the ontology is not limited in embodiments of the present disclosure. The type of the ontology can be predefined according to actual application situations.

A sub-node associated with the concept of the first target node can be a subgraph representing an instantiation of the ontology pointed to by the first target node, i.e., the node where the entity representing the specific type of the ontology is. For example, when the concept of the first target node is a piece of artwork (ontology), the sub-node associated with the first target node can be a node where the specific content of the artwork is.

When the AMR graph is traversed up and down, if an encountered first target node belongs to the set of the predefined entity type, the sub-graph representing the instantiation of the ontology type pointed to by the first target node can be compressed, and the first target node and the sub-nodes associated with the concept of the first target node can be replaced. A plurality of sub-nodes can be associated with the first target node and the concept of the first target node. After compression of the subgraph representing the instantiation of the ontology type, only a single node remains. By compressing the plurality of nodes into one node and replacing the plurality of equivalent nodes, the nodes in the AMR graph can be compressed.

It can be understood that, before splitting the abstract meaning representation graph, some nodes in the abstract meaning representation graph can be compressed to reduce information interference. Not only the efficiency of information splitting can be improved, but also the accuracy of information splitting can be improved.

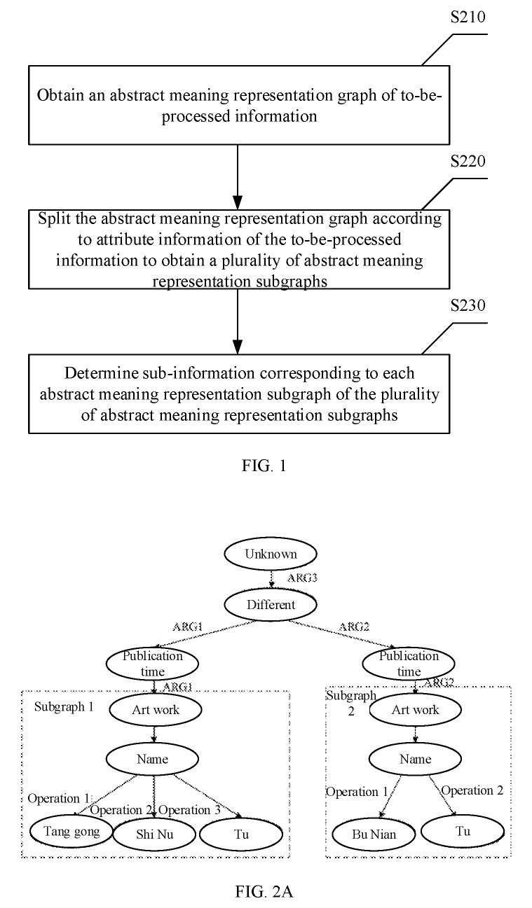

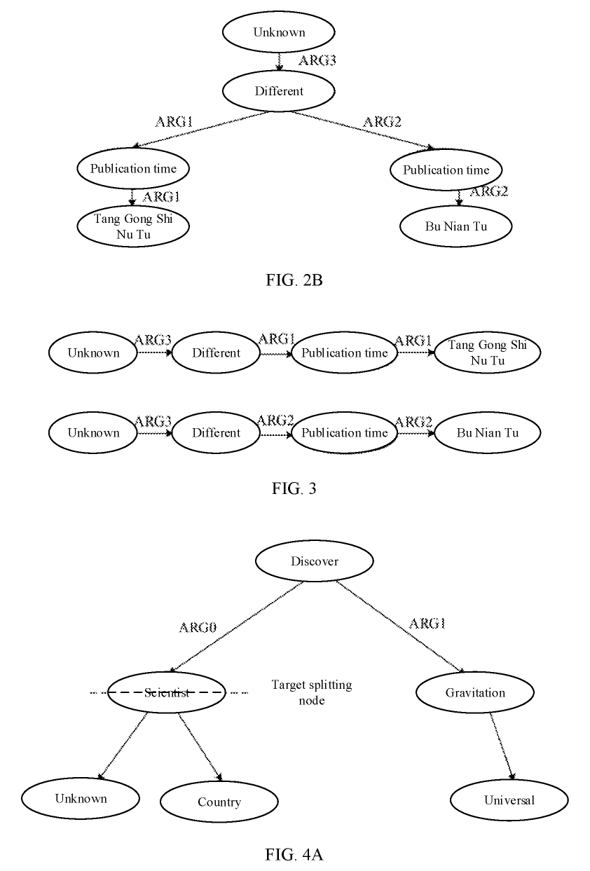

FIG. 2A is a schematic diagram of an abstract meaning representation graph before compression according to some embodiments of the present disclosure. FIG. 2B is a schematic diagram of an abstract meaning representation graph after compression according to some embodiments of the present disclosure, to-be-processed information including at least two parallel intentions.

As described above, in the operation of compressing the sub-nodes associated with the concept of the first target node can be performed to replace the first target node and the sub-nodes associated with the concept of the first target node. In some embodiments, the operation can further include, when the first target node has a target sub-node, merging the leaf nodes connected to the target sub-node to obtain a compressed node, the concept of the target sub-node representing the ontology name, and replacing the first target node and the sub-node associated with the concept of the first target node with the compressed node.

Exemplarily, the target sub-node can be a node with the concept as “name.” The target sub-node can be a node representing the type of the ontology in the first target node, that is, the concept of the target sub-node is “name.”

The leaf nodes can be the specific content of the name of the ontology in the first target node. By merging all the concepts of the leaf nodes under the “name” node corresponding to the “ontology” node, the specific content of the ontology can be obtained.

It should be noted that, during node compression, only when a node belongs to the set of predefined entity types, and the node has a “name” sub-node, all the leaf nodes corresponding to the “name” sub-node can be merged to obtain the compressed node. The sub-nodes without “name” connected to the node do not need to be compressed.

For example, the to-be-processed information can include “How do the publication times of Tang Gong Shi Nu Tu and Bu Nian Tu (the Painting of Maidens of Tang Palace and the Painting of Imperial Possession)differ?” The abstract meaning representation graph corresponding to the to-be-processed information is shown in FIG. 2A. The abstract meaning representation graph can be traversed from top to bottom. The “artwork” node can belong to the set of predefined entity types. The sub-graph representing the instantiation of the artwork type pointed to by the “artwork” can be compressed.

In FIG. 2A, two nodes correspond to “artwork,” and the two nodes correspond to paths of ARG 1 and ARG 2, respectively. In ARG 2 path, the “artwork” node includes “name” sub-nodes. In ARG 1 path, the subgraph representing the instantiation of the artwork pointed to by the “artwork” node corresponds to subgraph 1. Then, subgraph 1 can be compressed. Starting from the “name” sub-node, the leaf nodes with the edge type connected to the “name” sub-node in subgraph 1 can be merged into a single node to obtain the first compression node “Tang Gong (Tang Palace) Shi Nu (Maiden) Tu (Painting).” That is, the leaf nodes connected to edge “operation 1” to “operation 3” can be merged into a term or phrase as the first compression node. Other sub-nodes originally connected to the “artwork” node and the edges can remain. The first compression node “Tang Gong Shi Nu Tu” can be used to replace a part of subgraph 1 to obtain the compressed abstract meaning representation graph as shown in FIG. 2B.

Similarly, in ARG 2 path, the “artwork” node can have “name” sub-node. In ARG 2 path, the subgraph representing the instantiation of the artwork pointed to by the “artwork” node can correspond to subgraph 2. Then, subgraph 1 can be compressed. Starting from the “name” sub-node, the leaf nodes with edge type as “operator” connected to the “name” sub-node are merged into a single node to obtain the second compression node “Bu Nian (Imperial Possession) Tu (Painting).” That is, the leaf nodes connected to edge “operation 1” and “operation 2” in subgraph 2 can be merged into a term or phrase as the second compression node. Other sub-nodes and edges originally connected to the “artwork” node can remain. The second compression node “Bu Nian Tu” can be used to replace a part of the subgraph 2 to obtain the abstract meaning representation graph after compression, in FIG. 2B.

A plurality of sub-nodes can be associated with the first target node and the concept of the first target node. Only one node remains after compressing the subgraph representing the instantiation of the ontology type pointed to by the first target node. The plurality of nodes can be compressed into one node to replace the plurality of equivalent nodes to compress the nodes in AMR graph. Thus, the structure of the compressed AMR graph can be clearer, which facilitates the subsequent splitting and sequencing.

The attribute information of the to-be-processed information can be understood as the type information of sentences in the to-be-processed information. For example, a sentence can be of the parallel type. A parallel-type sentence can refer to a sentence in which, in linguistic expression, there is no obvious dependency relationship between two or more items. One type, a contrastive sentence can refer to a sentence that highlights differences or similarities between two or more items through comparison in linguistic expression. For example: “What is the difference in release time between Tang Gong Shi Nu Tu and Bu Nian Tu?” A sentence can be of a bridging type. A bridging-type sentence can refer to a sentence that explains references or relations through implicit information or context. One type, a conditional sentence, for example, “What is the nationality of the inventor of universal gravitation?” A sentence can simultaneously have both contrastive and bridging types. For example, “Dali likes to drink coffee, while his father usually drinks tea, but today he decided to try coffee.” The following provides explanations by using a contrastive question, a bridging question, and a question that contains both contrastive and bridging types as an example.

FIG. 3 is a schematic diagram of an abstract meaning representation subgraph according to some embodiments of the present disclosure, to-be-processed information including at least two parallel intentions.

As described above, when the attribute information characterizes that the to-be-processed information includes at least two parallel intentions, at S220, the abstract meaning representation graph can be split according to the attribute information of the to-be-processed information to obtain a plurality of abstract meaning representation subgraphs. In some embodiments, as shown in FIG. 3, this operation can further include operation S221a to operation S222a.

At S221a, a plurality of longest target paths are determined in the abstract meaning representation graph. The plurality of target paths can include the same types of concepts and/or semantic relations. The meanings represented by at least some concepts in the plurality of target paths are different.

At S222a, according to the plurality of target paths, a plurality of abstract meaning representation subgraphs are determined.

As an example, the attribute information can characterize that the to-be-processed information can include at least two parallel intentions, indicating that the type of the to-be-processed information is parallel type. Based on the contrastive-type example, the to-be-processed information: “What is the difference in release time between the Tang Gong Shi Nu Tu and Bu Nian Tu?” belongs to a contrastive question. Correspondingly, the original abstract meaning representation graph is as shown in FIG. 2A, and the compressed abstract meaning representation graph is shown in FIG. 2B.

During the process of splitting the abstract meaning representation graph into subgraphs, the compressed abstract meaning representation graph can be used for splitting. A contrastive-type sentence can include two content items that need to be compared, and a logical characteristic of the comparison can be reflected in the abstract meaning representation graph by producing two parallel paths (ARG 1 and ARG 2) containing attributes or entities.

A path can be formed by nodes and edges. A longest path can be a path containing the most edges or nodes.

The plurality of target paths, including the same types of concepts and/or semantic relations, can mean that the plurality of target paths each can contain entities of different concepts. For example, target path 1 can include entity A, and target path 2 can include entity B. In some other embodiments, the plurality of target paths can include different semantic relations, respectively. For example, target path 1 can include a first semantic relation (“cold”), and target path 2 can include a second semantic relation (“hot”), where the first semantic relation and the second semantic relation can be antonyms. When different target paths include different concepts or different semantic relations, the semantics represented by different target paths can be different.

Therefore, two longest identical paths can be extracted from the compressed abstract meaning representation graph to capture these parallel conditions or entities, respectively, to obtain the plurality of target paths. In some embodiments, the abstract meaning representation graph can be first linearized into a symbolic sequence composed of concepts and relations, and then the longest sequence can be regarded as the recognized parallel conditions or entities to obtain the plurality of target paths.

For example, continuing to refer to FIG. 2B, ARG 1 includes the entity of “Tang Gong Shi Nu Tu”, and ARG 2 includes the entity of “Bu Nian Tu”, and the ARG 1 and ARG 2 paths are the longest. Then, ARG 1 can be regarded as the first target path, and ARG 2 can be regarded as the second target path. Both ARG 1 and ARG 2 target paths contain entities, but the entity “Tang Gong Shi Nu Tu” in ARG 1 and the entity “Bu Nian Tu” in ARG 2 represent different entity concepts. According to the different target paths, the compressed abstract meaning representation graph can be split. The first target path corresponds to the first abstract meaning representation subgraph, and the second target path corresponds to the second abstract meaning representation subgraph, as shown in FIG. 3.

Sub-information can be generated according to the term property of the nodes in the subgraph. Then, the number of calls to the large model can be reduced. Thus, not only the efficiency of information decomposition can be improved, but also the consistency and usability of the information decomposition effect can be ensured.

As described above, at S230, the sub-information corresponding to each abstract meaning representation subgraph can be determined. In some embodiments, this operation can further include, when the concept of the second target node in the first abstract meaning representation subgraph represents an entity or a predicate, concatenating the concepts of a plurality of nodes between the first starting node and the first ending node to obtain the first sub-information. The first starting node and the first ending node can belong to the second target node.

As an example, the second target node can be a node whose concept is an entity or a predicate. The first starting node can be an entity node among the second target node. The first ending node can be a predicate node among the second target node. In some other embodiments, the first starting node can be a predicate node among the second target node, and the first ending node can be an entity node among the second target node. The concept attributes of the first starting node and the first ending node can be different.

For contrastive-type sentences, since the contents of the contrastive-type sentences are logically parallel and have no dependency relationship, the abstract meaning representation subgraph obtained from decomposition and the term property tagging information in the lexical structure can be directly used to generate the corresponding sub-information. For the nodes in each abstract meaning representation subgraph, if the nodes belong to a predicate or an entity, the nodes can be combined using spaces as delimiters in the order from top to bottom or from bottom to top to obtain the sub-information. For example, in the decomposed subgraph of FIG. 3, “release time” and “Tang Gong Shi Nu Tu” are respectively classified by term property analysis as predicate and entity in sequence. Therefore, “the release time of Tang Gong Shi Nu Tu” is used as the sub-information corresponding to the subgraph.

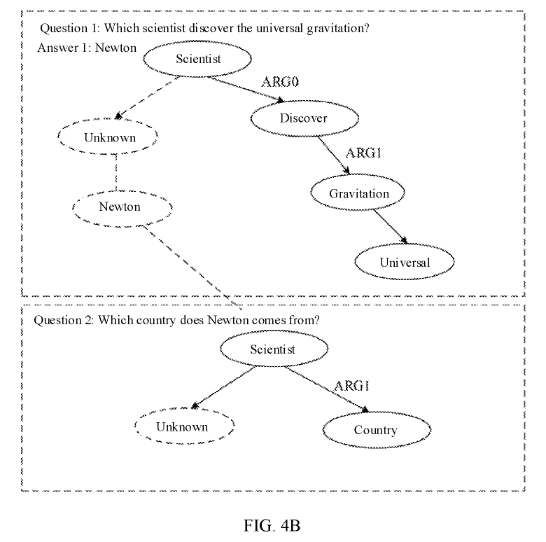

FIG. 4A is a schematic diagram of another abstract meaning representation graph according to some embodiments of the present disclosure, to-be-processed information including at least two serial intentions. FIG. 4B is a schematic diagram of another abstract meaning representation subgraph according to some embodiments of the present disclosure, to-be-processed information including at least two serial intentions.

As described above, when the attribute information characterizes that the to-be-processed information includes at least two sequential intentions, at S220, the abstract meaning representation graph is decomposed according to the attribute information of the to-be-processed information to obtain a plurality of abstract meaning representation subgraphs. In some embodiments, this operation can further include operation S221b to operation S222b.

At S221b, the abstract meaning representation graph is traversed to determine a target splitting node, the target splitting node representing a boundary point of a plurality of intentions within the to-be-processed information.

At S222b, according to the target splitting node, the abstract meaning representation graph is split to obtain the plurality of abstract meaning representation subgraphs, wherein the plurality of abstract meaning representation subgraphs respectively lie on different sides of the target splitting node.

For example, the attribute information can characterize that the to-be-processed information includes at least two sequential intentions, indicating that the to-be-processed information is of the bridging type.

The target splitting point can be the boundary point between different sequential intentions. The abstract meaning representation graph can be split using the target splitting point. Then, subgraphs in the abstract meaning representation graph that contain different intentions can be separated.

Bridging-type sentences may need to answer entities that are not explicitly mentioned. Therefore, identifying the unknown entity referred to in the question becomes the key to solving such problems. For example, the to-be-processed information of “What is the nationality of the inventor of universal gravitation?” can belong to a bridging-type question. Correspondingly, the original abstract meaning representation graph is as shown in FIG. 4A. This to-be-processed information contains two intentions. The first intention is “Who is the inventor of universal gravitation?” The second intention is “What is the nationality of the inventor?” The answer to the second intention depends on the answer to the first intention. Therefore, by traversing the abstract meaning representation graph, the boundary point “scientist” between the different intentions can be found as the target splitting point, and the abstract meaning representation graph can be split into two abstract meaning representation subgraphs, as shown in FIG. 4B. The two abstract meaning representation subgraphs respectively lie on the two sides of the boundary point “scientist.”

As described above, at S221b, the sub-information corresponding to each abstract meaning representation subgraph is determined. In some embodiments, this operation can further include, when the head node and tail node of a target edge in the abstract meaning representation graph belong to an entity or a predicate, taking the tail node of the target edge as the splitting node and taking the splitting node having the largest distance to the terminal node of the abstract meaning representation graph as the target splitting node.

A target edge can include nodes at two edge ends, where one can be an entity, and the other one can be a predicate. The head node can be the entity, and the tail node can be the predicate, or the head node can be the predicate, and the tail node can be the entity, which is not limited in embodiments of the present disclosure.

For example, one intention can correspond to a two-hop bridging question with an unknown entity. Each edge in the abstract meaning representation graph of FIG. 4A is traversed. If the head node of the edge is an entity (noun) and the tail node is a predicate, the edge can be used as a target edge, and the tail node in this target edge can be used as a splitting node and can be added to a candidate graph-splitting-node set. The candidate graph-splitting-node set can include one or a plurality of splitting nodes. Distances of the splitting nodes in the candidate graph-splitting-node set to the terminal node (leaf node) of the abstract meaning representation graph can be calculated. The splitting node with the longest distance to the terminal node (leaf node) of the abstract meaning representation graph can be used as the target splitting node. The target splitting node can have the longest distance to the terminal node (leaf node) of the abstract meaning representation graph, i.e., can include the most complete information. The AMR graph can be split at the target splitting node to obtain two subgraphs representing two sub-questions. Question 1 can be on a side including the target splitting node, and Question 2 can be on a side not including the target splitting node. Question 1 and Question 2 can be used as an answer sequence for a final bridging-type question.

For the subgraphs after splitting, the sub-information corresponding to the subgraphs can be obtained in the same manner as the above method for determining corresponding sub-information according to the subgraphs for the contrastive-type sentences.

For example, continuing to refer to FIGS. 4A and 4B, the to-be-processed information of “What is the nationality of the inventor of universal gravitation?” belongs to a bridging-type question, and the corresponding original abstract meaning representation graph is as shown in FIG. 4A. By traversing each edge of FIG. 4A, the first head node is “discover” (predicate) and the first tail node is “scientist” (entity), and the second head node is “discover” (predicate) and the second tail node is “scientist” (entity). Since the node “universal” is an adverb, which modifies the node “gravity”, and is not a leaf node in the abstract meaning representation graph, the distance from the node “gravity” to the leaf node is 0. However, the distance from “scientist” to the leaf node (country) is 1. Thus, the node where “scientist” is located is taken as the target splitting node. The two subgraphs as shown in FIG. 4B are obtained after splitting. The first subgraph corresponds to Question 1, and the second subgraph corresponds to Question 2. The answer to Question 1 serves as the positional entity in Question 2 and is the key information for solving Question 2. In Question 1, “discover” and “gravity” are respectively classified as a predicate and an entity according to term property analysis. Therefore, “who discovered universal gravitation” is taken as the sub-information corresponding to this subgraph. Corresponding Answer 1 is Newton. Then, “Newton” is used to replace the concept “scientist” in Question 2. In Question 2, “country” is a verb and is not used as a noun. Therefore, “scientist” and “country” are respectively classified as entity and predicate according to term property analysis. Thus, “Newton comes from which” is taken as the sub-information corresponding to Question 2.

Information decomposition can be performed on the to-be-processed information. The core can include searching for a splitting node to split the original compressed abstract meaning representation graph into the plurality of abstract meaning representation subgraphs. On one hand, the syntactic and semantic information contained in the structure of the abstract meaning representation graph needs to be used. On the other hand, whether the node belongs to an entity or predicate needs to be determined in connection with the lexical information, such as the term property of the node concepts. The lexical information can be supplemented by performing term property tagging on the original sentence using the natural language processing library.

As described above, when the attribute information characterizes that the to-be-processed information includes sequential intentions and parallel intentions, at S220, according to the attribute information of the to-be-processed information, the abstract meaning representation graph can be split to obtain the plurality of abstract meaning representation subgraphs. In some embodiments, Operation S220 can further include Operation S221c to Operation S224c.

At S221c, the abstract meaning representation graph is traversed to determine the target splitting node, and the target splitting node represents the boundary point of the plurality of intentions in the to-be-processed information.

At S222c, according to the target splitting node, the abstract meaning representation graph is split to obtain a plurality of initial abstract meaning representation subgraphs, where the plurality of initial abstract meaning representation subgraphs respectively lie on different sides of the target splitting node.

At S223c, when the initial abstract meaning representation subgraph includes at least two parallel intentions, a plurality of target paths with the longest path in the initial abstract meaning representation subgraph are determined. The plurality of target paths include the same types of concepts and/or semantic relations, and the semantics represented by at least a part of the concepts are different in the plurality of target paths.

At S224c, according to the plurality of target paths, the plurality of target abstract meaning representation subgraphs are determined.

When the to-be-processed information includes at least two sequential intentions and at least two parallel intentions at the same time, a heuristic method can be adopted for processing. In a generalized problem definition, as long as the sentence includes the logic of two sequential intentions, the sentence can be considered a bridging-type sentence. Moreover, since the sentence is used as the graph construction unit in the AMR graph, and a sequential-parallel mixed sentence is usually long and contains a plurality of clauses, the result can correspond to a plurality of abstract meaning representation subgraphs and a plurality of unknown (AMR-unknown) nodes. A multi-clause question can be regarded as the process of splitting to obtain the subgraph in handling the bridging-type question. Thus, the mixed-type question can overall follow the question-decomposition procedure of bridging-type subgraph splitting and answering.

For the situation when a mixed-type problem subgraph can contain a contrastive-type problem, the following two processing methods can be adopted according to the actual situation. In the first method, when high precision is required for the information processing result, and rich computing resources are provided, a recursive method can be adopted. The abstract meaning representation graph can be split first in the bridging question method to obtain the initial abstract meaning representation subgraph to determine the initial sub-information corresponding to the initial abstract meaning representation graph. Then, the initial abstract meaning representation subgraph, including the contrastive question, can be further split in the contrastive question splitting method to obtain the target abstract meaning representation subgraph to further determine the target sub-information corresponding to the target abstract meaning representation subgraph. In the second method, when low precision is required for the information processing result, and the computing resources are limited, the mixed-type question can be split according to the bridging question, and the contrastive question may not be split anymore. That is, all context in connection with the contrastive question is in the clause, and the overall clause can be processed.

For Operation S221c to Operation S222c, reference can be made to the description of Operation S221b to Operation S222b, which is not repeated here. For Operation S223c to Operation S224c, reference can be made to the description of Operation S221a to Operation S222a, which is not repeated here.

For example, if the to-be-processed information includes bridging sentences and contrastive sentences, the model can be pre-identified as a bridging sentence. When the computing resources are rich, and the user has a high precision requirement on the information processing result, the abstract meaning representation graph corresponding to the to-be-processed information can be compressed to obtain the compressed abstract meaning representation graph. The compressed abstract meaning representation graph can be traversed. If the head node of the edge is an entity (noun) and the tail node of the edge is a predicate, the edge can be used as the target edge. The tail node of the target edge can be used as the splitting node and can be added to the candidate graph-splitting-node set. Distances from the splitting nodes of the candidate graph-splitting-node set to the terminal node (leaf node) of the abstract meaning representation graph can be calculated. The splitting node with the longest distance to the terminal node (leaf node) of the abstract meaning representation graph can be used as the target splitting node. The compressed abstract meaning representation graph can be split into a plurality of initial abstract meaning representation subgraphs according to the target splitting node. Further, when the initial abstract meaning representation subgraph includes the contrastive question, a plurality of longest target paths can be extracted from the initial abstract meaning representation subgraph. The target path can include different entities and semantic relations. According to the plurality of target paths, the initial abstract meaning representation subgraph can be further split to obtain a plurality of target abstract meaning representation subgraphs. Then, the sub-information corresponding to each initial abstract meaning representation subgraph and each abstract meaning representation subgraph can be determined.

As described above, when the attribute information characterizes that the to-be-processed information includes the serial intentions and parallel intentions, in operation S220, according to the attribute information of the to-be-processed information, the abstract meaning representation graph is split to obtain the plurality of abstract meaning representation subgraphs. In some other embodiments, this operation can further include operation S221d to operation S224d.

At S221d, a plurality of target paths with the longest target path are determined in the abstract meaning representation graph. The plurality of target paths include the same type of concepts and/or semantic relations, and at least part of the concepts represented in the plurality of target paths have different semantics.

At S222d, according to the plurality of target paths, the plurality of initial abstract meaning representation subgraphs are determined.

At S223d, the initial abstract meaning representation subgraphs are traversed to determine the target splitting node. The target splitting node represents the boundary point between the plurality of intentions in the to-be-processed information.

At S224d, according to the target splitting node, the initial abstract meaning representation subgraphs are split to obtain the plurality of target abstract meaning representation subgraphs, and the plurality of target abstract meaning representation subgraphs are respectively located on different sides of the target splitting node.

When the to-be-processed information includes at least two serial intentions and at least two parallel intentions, the overall mixed-type question can also follow the parallel-type subgraph-splitting-and-answering question-decomposition procedure.

For example, when the mixed-type question subgraph includes a bridging-type question, the following two processing methods can be adopted according to the actual situation. In the first method, when high precision of the information-processing result is required, and rich computing resources are provided, a recursive method can be adopted. That is, the abstract meaning representation graph is first split in the contrastive question method to obtain the initial abstract meaning representation subgraph. Then, the initial sub-information corresponding to the initial abstract meaning representation subgraph can be determined. Then, the initial abstract meaning representation subgraph that includes the bridging-type question can be further split using the bridging-type question splitting method to obtain the target abstract meaning representation subgraph to further determine the target sub-information corresponding to the target abstract meaning representation subgraph. In the second method, when low precision of the information-processing result is required, and limited computing resources are provided, the mixed-type question can be split according to the contrastive question, and the bridging-type question in the mixed-type question may no longer be split. That is, all context related to the bridging-type question may have already appeared in the clause, and the overall clause may be processed.

For operations S221c to S222c, reference can be made to the descriptions of operations S221b to S222b above, and are not repeated here. For operations S223c to S224c, reference can be made to the descriptions of operations S221a to S222a above and are not repeated here.

For example, the to-be-processed information can include the bridging-type sentence and contrastive sentence, and the model can pre-identify the to-be-processed information as the contrastive sentence. When rich computing resources are provided and the user requires high precision for the information processing result, the abstract meaning representation graph corresponding to the to-be-processed information can be compressed to obtain the compressed abstract meaning representation graph. The plurality of longest target paths can be extracted from the compressed abstract meaning representation graph. The target path can include different entities or semantic relations. The initial abstract meaning representation subgraph can be split according to the plurality of target paths to obtain the plurality of initial abstract meaning representation subgraphs. Further, when the initial abstract meaning representation subgraph includes the bridging-type question, the initial abstract meaning representation subgraphs can be traversed. If the head node of the edge in the initial abstract meaning representation subgraph is entity (noun), and the tail node is predicate, the edge can be used as the target edge, and the tail node of the target edge can be used as the splitting node, which can be added to the candidate graph-splitting node set. The distances from the splitting nodes to the candidate graph-splitting node set to the terminal node (leaf node) of the initial abstract meaning representation subgraph can be calculated, and the splitting node with the longest distance to the terminal node (leaf node) of the initial abstract meaning representation subgraph can be used as the target splitting node. The initial abstract meaning representation subgraph can be split into the plurality of target abstract meaning representation subgraphs according to the target splitting node. Then, the sub-information corresponding to each initial abstract meaning representation subgraph and each abstract meaning representation subgraph can be determined.

According to different attributes of the to-be-processed information, splitting can be performed for different logic manners using different splitting strategies. Thus, the accuracy and coverage of the information decomposition can be ensured.

At S230, the sub-information corresponding to each abstract meaning representation subgraph is determined. In some embodiments, operation S230 can further include operation S231 and operation S232.

At S231, the second abstract meaning representation subgraph and the to-be-processed information are input into the large model to obtain the second sub-information and the first query result corresponding to the second sub-information. The first query result characterizes the entity concept that appears for the first time in the query result corresponding to the second sub-information relative to the second abstract meaning representation subgraph.

At S232, the concept of the target splitting node of the third abstract meaning representation subgraph is replaced by the first query result and input into the large model to obtain the third sub-information.

The second abstract meaning representation subgraph can be the first question in the bridging-type question. The third abstract meaning representation subgraph can be the second question in the bridging-type question. The determination of the second question can depend on the answer to the first question. For example, referring to FIG. 4B, the second abstract meaning representation subgraph is Question 1, and the second abstract meaning representation subgraph is Question 2.

For the to-be-processed information including at least two serial intentions, since the second sub-information depends on the first query result of the first sub-information, the large model can be called to generate the sub-information sentence and answer in sequence. For the sub-information generation task, the first abstract meaning representation subgraph and the original question for generating the sub-information can be provided to allow the large language model to execute the restrictive generation task based on the AMR subgraph. The prompt can be consistent with the principle generated by the contrastive task. That is, the predicate and entity can be focused. The generated first sub-information can be sent to the large language model question-answer system to obtain the first query result. The large model can extract the entity in the first query result. The entity can be the concept appearing in the abstract meaning representation subgraph for the first time. The extracted entity can be replaced by the target splitting node of the second abstract meaning representation subgraph. The sub-information corresponding to the second abstract meaning representation subgraph can be determined according to the replaced second abstract meaning representation subgraph.

For example, the to-be-processed information of “What is the nationality of the inventor of universal gravitation?” is compressed and split to obtain the two abstract meaning representation subgraphs shown in FIG. 4B. The subgraphs including node “gravitation” and node “universal” and the to-be-processed information can be input to the large model. The large model can first generate the second sub-information according to the abstract meaning representation subgraph and answer the second sub-information to obtain the first query result of “Newton discovers universal gravitation.” “Newton” can be the entity that appears for the first time in the subgraph containing the node “gravitation” and node “universal.” “Newton” can then be used to replace the node “scientist” in the subgraph containing “country.” The replaced subgraph containing “country” can be input into the large model to obtain the third sub-information corresponding to the subgraph and the second query result corresponding to the third sub-information.

As described above, in operation S231, the second abstract meaning representation subgraph and the to-be-processed information are input into the large model to obtain the second sub-information and the first query result corresponding to the second sub-information. In some embodiments, operation S231 can further include Operation S2311 and Operation S2312.

At S2311, when the concept of the third target node in the second abstract meaning representation subgraph characterizes an entity or predicate, the concepts of the plurality of nodes between the second start node and the second end node are combined to obtain the second sub-information. The second start node and the second end node belong to the third target node.

At S2312, the second sub-information and the to-be-processed information are input into the large model to obtain the first query result.

Exemplarily, the third target node can be a node whose concept is an entity or a predicate. The second start node can be an entity node in the third target node, and the second end node can be a predicate node in the third target node. In some other embodiments, the second start node can be the predicate node in the third target node, and the second end node can be the entity node in the third target node. The concept attributes of the second start node and the second end node can be different.

For the nodes in each abstract meaning representation subgraph, if the nodes belong to a predicate or an entity (the third target node), then the nodes can be arranged in a top-down or bottom-up order with spaces as separators to obtain the sub-information.

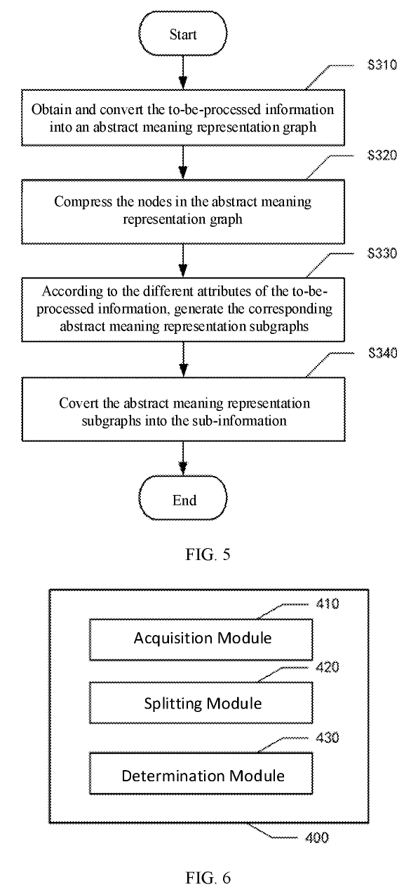

To facilitate understanding of the information decomposition method of embodiments of the present disclosure, further explanation is provided in connection with FIG. 5.

FIG. 5 is a schematic diagram showing a principle of an information decomposition method according to some embodiments of the present disclosure.

The information decomposition method of embodiments of the present disclosure includes Operation S310 to Operation S340.

At S310, the to-be-processed information is obtained and converted into an abstract meaning representation graph.

At S320, the nodes in the abstract meaning representation graph are compressed.

A top-down graph traversal can be performed on the abstract meaning representation graph. If the concept of the first target node in the abstract meaning representation graph belongs to a predefined set of entity types (ontology), and the first target node has a sub-node “Name,” the concepts of the leaf nodes connected to the sub-node “Name” can be combined to obtain a compressed node. The nodes in the subgraph representing instantiation of the ontology type pointed to by the first target node can be compressed and replaced with a single compressed node to obtain the compressed abstract meaning representation graph.

At S330, according to the different attributes of the to-be-processed information, the corresponding abstract meaning representation subgraphs are generated.

Further, according to the type (attribute) of the to-be-processed information, the compressed abstract meaning representation graph can be split to obtain the plurality of abstract meaning representation subgraphs. Splitting the compressed abstract meaning representation graph according to the different attributes of the to-be-processed information can refer to the above description and is not repeated here. The split abstract meaning representation subgraphs can be converted into the sub-information.

At S340, the abstract meaning representation subgraphs are converted into the sub-information.

For the nodes in each abstract meaning representation subgraph, if the nodes belong to the predicate or entity (the third target node), the nodes can be arranged in a top-down or bottom-up order with spaces as separators to obtain the sub-information. The large model can also be configured to generate the sub-information according to the subgraph.

In terms of time, using the term property tagging during the sub-question generation process can reduce the number of calls to the large model. In terms of space, the AMR parsing model of the method, as a basic module, can serve other functional modules for document parsing and document summarization applied on the large model terminal side. Thus, the storage space can have higher utilization.

Based on the above information decomposition method, the present disclosure further provides an information-decomposition apparatus. The apparatus is described in detail below with reference to FIG. 6.

FIG. 6 is a schematic structural diagram of the information decomposition apparatus 400 according to some embodiments of the present disclosure.

As shown in FIG. 6, the information-decomposition apparatus 400 of embodiments of the present disclosure includes an acquisition module 410, a splitting module 420, and a determination module 430.

The acquisition module 410 can be configured to obtain the abstract meaning representation graph of the to-be-processed information. The abstract meaning representation graph can include the plurality of nodes and edges that connect two nodes. The nodes can represent the concepts included in the to-be-processed information, and the edges can represent the semantic relations between two concepts. In some embodiments, the acquisition module 410 can be configured to execute Operation S210 described above, which is not repeated here.

The splitting module 420 can be configured to split the abstract meaning representation graph according to the attribute information of the to-be-processed information to obtain the plurality of abstract meaning representation subgraphs. Each abstract meaning representation subgraph can represent at least one intention included in the to-be-processed information. In some embodiments, the splitting module 420 can be configured to execute operation S220 described above, which is not repeated here.

The determination module 430 can be configured to determine the sub-information corresponding to each abstract meaning representation subgraph. The plurality of pieces of sub-information can be the results after decomposing the to-be-processed information. In some embodiments, the determination module 430 can be configured to execute operation S230 described above, which is not repeated here.

The information-decomposition apparatus can be used as a syntactic-analysis method, which can be arranged at the foundational capability layer of an entire terminal side large model. In addition to the complex question decomposition, the information-composition apparatus can also be applied to other members of the terminal side large model system, such as storing document analysis and creating indexing, slot extraction, and document summarization. Thus, the utilization of the storage space caused by introducing the AMR parsing model can be improved.

In embodiments of the present disclosure, any of the acquisition module 410, the splitting module 420, and the determination module 430 can be combined and implemented in one module, or any one of the acquisition module 410, the splitting module 420, and the determination module 430 can be divided into a plurality of modules. Alternatively, at least part of the functions of one or more of the acquisition module 410, the splitting module 420, and the determination module 430 can be combined with at least part of the functions of another module and implemented in one module. In embodiments of the present disclosure, at least one of the acquisition module 410, the splitting module 420, or the determination module 430 can be at least partially implemented as a hardware circuitry, such as a field-programmable gate array (FPGA), a programmable logic array (PLA), a system-on-chip, a system-in-package, an application-specific integrated circuit (ASIC), or any other reasonable manner of circuit integration or packaging, or can be implemented in any one or a suitable combination of software, hardware, and firmware. Alternatively, at least one of the acquisition module 410, the splitting module 420, or the determination module 430 can be at least partially implemented as a computer program module that, when executed, performs the corresponding functions.

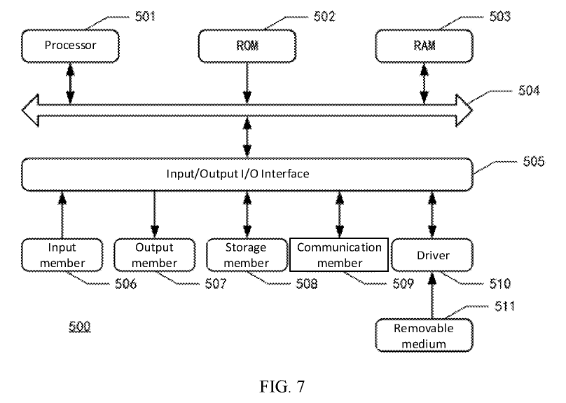

FIG. 7 is a schematic block diagram of an electronic device 500 suitable for implementing the information decomposition method according to some embodiments of the present disclosure.

As shown in FIG. 7, the electronic device 500 of embodiments of the present disclosure includes a processor 501. The processor 501 can be configured to execute various suitable actions and processing according to the programs stored in the ROM 502 or the programs loaded into the RAM 503 from the storage member 508. The processor 501 can include, for example, a general-purpose microprocessor (e.g., a CPU), an instruction-set processor and/or related chipset, and/or a dedicated microprocessor (e.g., an ASIC), etc. The processor 501 can further include onboard memory for caching purposes. The processor 501 can include a single processing unit or a plurality of processing units for executing the different actions of the method flow according to embodiments of the present disclosure.

Various programs and data required for the operation of the electronic device 500 can be stored in the RAM 503. The processor 501, the ROM 502, and the RAM 503 are connected to each other through a bus 504. The processor 501 can execute the various operations of the method flow according to embodiments of the present disclosure by executing the programs in the ROM 502 and/or the RAM 503. The programs can also be stored in one or more memories other than the ROM 502 and the RAM 503. The processor 501 can also execute the various operations of the method flow according to embodiments of the present disclosure by executing the programs stored in one or more memories.

In embodiments of the present disclosure, the electronic device 500 further includes an input/output (I/O) interface 505, which is also connected to the bus 504. The electronic device 500 further includes one or more of the following members connected to the I/O interface 505, such as an input member 506 including a keyboard, a mouse, etc., an output member 507 including devices such as a cathode ray tube (CRT), a liquid crystal display (LCD), and a speaker, a storage member 508 including a hard drive, and a communication member 509 including a network interface card such as a LAN card or modem. The communication member 509 can perform communication processing via a network such as the Internet. A driver 510 is also connected to the I/O interface 505 as needed. A removable medium 511, such as a magnetic disk, optical disk, magneto-optical disk, semiconductor memory, etc., is arranged on the driver 510 as needed, so that a computer program read from the removable medium 511 can be installed in the storage member 508 as needed.

The present disclosure also provides a computer-readable storage medium, which can be included in the device/apparatus/system described above, or can exist independently without being installed in the device/apparatus/system. The above computer- readable storage medium can carry one or more programs that, when executed, implement the method of embodiments of the present disclosure.

In embodiments of the present disclosure, the computer-readable storage medium can be a non-volatile computer-readable storage medium, and can include but is not limited to, portable computer disks, hard drive, random-access memory (RAM), read-only memory (ROM), erasable programmable read-only memory (EPROM or flash memory), portable compact-disk read-only memory (CD-ROM), optical storage devices, magnetic storage devices, or any suitable combination thereof. In the present disclosure, a computer-readable storage medium can be any tangible medium that contains or stores a program. The program can be used by or in combination with an instruction-execution system, apparatus, or device. For example, in embodiments of the present disclosure, the computer-readable storage medium can include the ROM 502 and/or the RAM 503 described above and/or one or more memories other than the ROM 502 and RAM 503.

The embodiments of the present disclosure can further include a computer program product including a computer program. The computer program can include program codes for executing the method shown in the flowchart. When the computer program product runs in the computer system, the program codes can cause the computer system to implement the information decomposition method of embodiments of the present disclosure.

When the computer program is executed by the processor 501, the functions defined in the system/apparatus of embodiments of the present disclosure can be executed. In embodiments of the present disclosure, the system, apparatus, modules, units, etc. described above can be implemented by the computer program modules.

In some embodiments, the computer program can be stored on a tangible storage medium such as an optical storage device or magnetic storage device. In some other embodiments, the computer program can also be transmitted and distributed over a network medium in the form of signals, and downloaded and installed through the communication member 509 and/or installed from the removable medium 511. The program codes included in the computer program can be transmitted via any suitable network medium, including but not limited to, wireless, wired, or any suitable combination thereof.

In some embodiments, the computer program can be downloaded and installed from the network through the communication member 509 and/or installed from the removable medium 511. When the computer program is executed by the processor 501, the above-defined functions of the system of embodiments of the present disclosure can be executed. In embodiments of the present disclosure, the system, device, apparatus, modules, units, etc. described above can be implemented by computer program modules.

In embodiments of the present disclosure, the program codes for executing the computer program provided in embodiments of the present disclosure can be written in any combination of one or more programming languages. In some embodiments, the computer program can be implemented by high-level procedural and/or object-oriented programming languages and/or assembly/machine languages. The programming languages can include but are not limited to Java, C++, Python, C language, or similar programming languages. The program codes can be executed entirely on the user computing device, partly on the user device, partly on a remote computing device, or entirely on a remote computing device or server. When involving a remote computing device, the remote computing device can be connected to the user computing device via any type of network, including a local-area network (LAN) or wide-area network (WAN), or may be connected to an external computing device (for example, an Internet service provider for the Internet).

The flowcharts and block diagrams in the accompanying drawings illustrate the architectures, functions, and operations possibly implemented by the system, method, and computer program product of embodiments of the present disclosure. Thus, each block in a flowchart or block diagram can represent a module, program segment, or portion of codes. The module, program segment, or portion of codes can include one or more executable instructions for implementing a specified logical function. In some alternative implementations, the functions indicated in the block can occur in an order different from that shown in the drawings. For example, two blocks shown sequentially may actually be executed substantially in parallel, or sometimes in a reverse order, depending on the functions involved. Each block in the block diagrams or flowcharts, and combinations of blocks in the block diagrams or flowcharts, may be implemented using dedicated hardware-based systems that perform the specified functions or operations, or using a combination of dedicated hardware and computer instructions.

Those skilled in the art can understand that the features described in the various embodiments and/or claims of the present disclosure may be combined and/or integrated in various ways, even if such combinations or integrations are not explicitly described in the present disclosure. In particular, without departing from the spirit and teachings of the present disclosure, the features described in the various embodiments and/or claims of the present disclosure may be combined and/or integrated in a plurality of ways. All such combinations and/or integrations are within the scope of the present disclosure.

Embodiments of the present disclosure have been described above. However, these embodiments are merely for illustrative purposes and are not intended to limit the scope of the present disclosure. Although the various embodiments are described separately above, this does not mean that the measures in the individual embodiments cannot be advantageously combined. The scope of the present disclosure is defined by the appended claims and their equivalents. Without departing from the scope of the present disclosure, various alternatives and modifications may be made by those skilled in the art, and all such alternatives and modifications shall fall within the scope of the present disclosure.

What is claimed is:

1. An information decomposition method comprising:
obtaining an abstract meaning representation graph of to-be-processed information, the abstract meaning representation graph including a plurality of nodes and edges for connecting two of the plurality of nodes, a node representing a concept included in the to-be-processed information, and an edge representing a semantic relation between two concepts;
splitting the abstract meaning representation graph according to attribute information of the to-be-processed information to obtain a plurality of abstract meaning representation subgraphs, the abstract meaning representation subgraphs representing that the to-be-processed information includes at least one intention; and
determining sub-information corresponding to each abstract meaning representation subgraph of the plurality of abstract meaning representation subgraphs, a plurality of pieces of sub-information being results of decomposing the to-be-processed information.

2. The method according to claim 1, further comprising:
in response to a concept of a first target node representing an ontology, compressing sub-nodes associated with the concept of the first target node to replace the first target node and the sub-nodes associated with the concept of the first target node, the ontology representing a system of entities having a same attribute.

3. The method according to claim 2, wherein compressing the sub-nodes associated with the concept of the first target node to replace the first target node and the sub-nodes associated with the concept of the first target node includes:
in response to the first target node including a target sub-node, merging leaf nodes connected to the target sub-node to obtain a compressed node, the target sub-node representing a name of the ontology; and
replacing the first target node and the sub-nodes associated with the concept of the first target node with the compressed node.

4. The method according to claim 1, where in response to the attribute information characterizing that the to-be-processed information includes at least two parallel intentions, splitting the abstract meaning representation graph according to the attribute information of the to-be-processed information to obtain the plurality of abstract meaning representation subgraphs including:
determining a plurality of target paths with a longest path in the abstract meaning representation graph, the plurality of target paths including concepts and/or semantic relations of a same type, and at least a part of the concepts of the plurality of target paths representing different semantics; and
determining the plurality of abstract meaning representation subgraphs according to the plurality of target paths.

5. The method according to claim 4, wherein determining sub-information corresponding to each abstract meaning representation subgraph of the plurality of abstract meaning representation subgraphs includes:
in response to a second target node of a first abstract meaning representation subgraph representing an entity or predicate, splicing concepts of a plurality of nodes from a first start node to a first end node to obtain first sub-information, the first start node and the first end node belonging to the second target node.

6. The method according to claim 1, wherein in response to the attribute information representing that the to-be-processed information includes at least two serial intentions, splitting the abstract meaning representation graph according to the attribute information of the to-be-processed information to obtain the plurality of abstract meaning representation subgraphs includes:
traversing the abstract meaning representation graph to determine a target splitting node, the target splitting node representing a boundary point of a plurality of intentions in the to-be-processed information; and
splitting the abstract meaning representation graph according to the target splitting node to obtain the plurality of abstract meaning representation subgraphs, the plurality of abstract meaning representation subgraphs being located on different sides of the target split node.

7. The method according to claim 6, wherein traversing the abstract meaning representation graph to determine the target splitting node includes:
in response to a head node and a tail node of a target edge of the abstract meaning representation graph belonging to an entity or predicate, using the tail node of the target edge as a splitting node; and
using a splitting node having a longest distance to a terminal node of the abstract meaning representation graph as the target splitting node.

8. The method according to claim 1, wherein in response to the attribute information representing that the to-be-processed information includes the serial intentions and parallel intentions, splitting the abstract meaning representation graph according to the attribute information of the to-be-processed information to obtain the plurality of abstract meaning representation subgraphs includes:
traversing the abstract meaning representation graph to determine a target splitting node, the target splitting node representing a boundary point of a plurality of intentions in the to-be-processed information;
splitting the abstract meaning representation graph according to the target splitting node to obtain a plurality of initial abstract meaning representation subgraphs, the plurality of initial abstract meaning representation subgraphs being located on different sides of the target splitting node;
in response to an initial abstract meaning representation subgraph including at least two parallel intentions, determining a plurality of longest target paths in the initial abstract meaning representation subgraph, the plurality of target paths including concepts and/or semantic relations of the same type, and at least some concepts of the plurality of target paths representing different semantics; and
determining a plurality of target abstract meaning representation subgraphs according to the plurality of target paths; or
determining the plurality of longest target paths in the abstract meaning representation graph, the plurality of target paths including concepts and/or semantic relations of the same type, and at least some concepts of the plurality of target paths representing different semantics;
determining a plurality of initial abstract meaning representation subgraphs according to the plurality of target paths;
traversing the initial abstract meaning representation subgraphs to determine a target splitting node, the target splitting node representing a boundary point of plurality of intentions in the to-be-processed information; and
splitting the initial abstract meaning representation subgraphs according to the target splitting node to obtain a plurality of target abstract meaning representation subgraphs, the plurality of target abstract meaning representation subgraphs being located on different sides of the target splitting node.

9. The method according to claim 6, wherein determining the sub-information corresponding to each abstract meaning representation subgraph of the plurality of abstract meaning representation subgraphs includes:
inputting a second abstract meaning representation subgraph and the to-be-processed information into a large model to obtain second sub-information and a first query result corresponding to the second sub-information, the first query result representing an entity concept that first appears in a query result corresponding to the second sub-information relative to the second abstract meaning representation subgraph;
replacing a concept of a target splitting node of a third abstract meaning representation subgraph with the first query result, and inputting the third abstract meaning representation subgraph into the large model to obtain third sub-information.

10. An electronic device comprising:
one or more processors; and
one or more memories storing one or more computer programs that, when executed by the one or more processors, cause the one or more processors to:
obtain an abstract meaning representation graph of to-be-processed information, the abstract meaning representation graph including a plurality of nodes and edges for connecting two of the plurality of nodes, a node representing a concept included in the to-be-processed information, and an edge representing a semantic relation between two concepts;
split the abstract meaning representation graph according to attribute information of the to-be-processed information to obtain a plurality of abstract meaning representation subgraphs, the abstract meaning representation subgraphs representing that the to-be-processed information includes at least one intention; and
determine sub-information corresponding to each abstract meaning representation subgraph of the plurality of abstract meaning representation subgraphs, a plurality of pieces of sub-information being results of decomposing the to-be-processed information.

11. The electronic device according to claim 10, wherein the one or more processors are further configured to:
in response to a concept of a first target node representing an ontology, compress sub-nodes associated with the concept of the first target node to replace the first target node and the sub-nodes associated with the concept of the first target node, the ontology representing a system of entities having a same attribute.

12. The electronic device according to claim 11, wherein the one or more processors are further configured to:
in response to the first target node including a target sub-node, merge leaf nodes connected to the target sub-node to obtain a compressed node, a concept of the target sub-node representing a name of the ontology; and
replace the first target node and the sub-nodes associated with the concept of the first target node with the compressed node.

13. The electronic device according to claim 10, where the one or more processors are further configured to:
determine a plurality of target paths with a longest path in the abstract meaning representation graph, the plurality of target paths including concepts and/or semantic relations of a same type, and at least a part of the concepts of the plurality of target paths representing different semantics; and
determine the plurality of abstract meaning representation subgraphs according to the plurality of target paths.

14. The electronic device according to claim 13, wherein the one or more processors are further configured to:
in response to a concept of a second target node of a first abstract meaning representation subgraph representing an entity or predicate, splice concepts of a plurality of nodes from a first start node to a first end node to obtain first sub-information, the first start node and the first end node belonging to the second target node.

15. The electronic device according to claim 10, wherein the one or more processors are further configured to:
traverse the abstract meaning representation graph to determine a target splitting node, the target splitting node representing a boundary point of a plurality of intentions in the to-be-processed information; and
split the abstract meaning representation graph according to the target splitting node to obtain a plurality of abstract meaning representation subgraphs, the plurality of abstract meaning representation subgraphs being located on different sides of the target split node.

16. The electronic device according to claim 15, wherein the one or more processors are further configured to:
in response to a head node and a tail node of a target edge of the abstract meaning representation graph belonging to an entity or predicate, use the tail node of the target edge as a splitting node; and
use a splitting node having a longest distance to a terminal node of the abstract meaning representation graph as the target splitting node.

17. The electronic device according to claim 10, wherein the one or more processors are further configured to:
traverse the abstract meaning representation graph to determine a target splitting node, the target splitting node representing a boundary point of a plurality of intentions in the to-be-processed information;
split the abstract meaning representation graph according to the target splitting node to obtain a plurality of initial abstract meaning representation subgraphs, the plurality of initial abstract meaning representation subgraphs being located on different sides of the target splitting node;
in response to an initial abstract meaning representation subgraph including at least two parallel intentions, determine a plurality of longest target paths in the initial abstract meaning representation subgraph, the plurality of target paths including concepts and/or semantic relations of the same type, and at least some concepts of the plurality of target paths representing different semantics; and
determine a plurality of target abstract meaning representation subgraphs according to the plurality of target paths; or
determine the plurality of longest target paths in the abstract meaning representation graph, the plurality of target paths including concepts and/or semantic relations of the same type, and at least some concepts of the plurality of target paths representing different semantics;
determine a plurality of initial abstract meaning representation subgraphs according to the plurality of target paths;
traverse the initial abstract meaning representation subgraphs to determine a target splitting node, the target splitting node representing a boundary point of plurality of intentions in the to-be-processed information; and
split the initial abstract meaning representation subgraphs according to the target splitting node to obtain a plurality of target abstract meaning representation subgraphs, the plurality of target abstract meaning representation subgraphs being located on different sides of the target splitting node.

18. The electronic device according to claim 15, wherein the one or more processors are further configured to:
input a second abstract meaning representation subgraph and the to-be-processed information into a large model to obtain second sub-information and a first query result corresponding to the second sub-information, the first query result representing an entity concept that first appears in a query result corresponding to the second sub-information relative to the second abstract meaning representation subgraph;
replace a concept of a target splitting node of a third abstract meaning representation subgraph with the first query result, and inputting the third abstract meaning representation subgraph into the large model to obtain third sub-information.

19. A computer-readable storage medium storing one or more computer programs that, when executed by one or more processors, cause the one or more processors to:
obtain an abstract meaning representation graph of to-be-processed information, the abstract meaning representation graph including a plurality of nodes and edges for connecting two of the plurality of nodes, a node representing a concept included in the to-be-processed information, and an edge representing a semantic relation between two concepts;
split the abstract meaning representation graph according to attribute information of the to-be-processed information to obtain a plurality of abstract meaning representation subgraphs, the abstract meaning representation subgraphs representing that the to-be-processed information includes at least one intention; and
determine sub-information corresponding to each abstract meaning representation subgraph of the plurality of abstract meaning representation subgraphs, a plurality of pieces of sub-information being results of decomposing the to-be-processed information.

20. The computer-readable storage medium according to claim 19, wherein the one or more processors are further configured to:
in response to a concept of a first target node representing an ontology, compress sub-nodes associated with the concept of the first target node to replace the first target node and the sub-nodes associated with the concept of the first target node, the ontology representing a system of entities having a same attribute.
